(19) United States
(12) Patent Application Publication
(10) Pub. No.: US 2012/0111068 A1
(43) Pub. Date: May 10, 2012

(54) PADLOCK PROTECTOR AND METHOD OF USE

(76) Inventors: Ronald J. Pasky, Erie, PA (US); Frank J. DePetri, Canton, OH (US)

(21) Appl. No.: 13/291,611

(22) Filed: Nov. 8, 2011

Related U.S. Application Data
(60) Provisional application No. 61/411,580, filed on Nov. 9, 2010.

(51) Int. Cl. E05B 67/38

(52) U.S. Cl. 70/56

(57) ABSTRACT

A padlock protector and method of use includes a padlock cover assembly having a padlock cover for receiving therein a padlock. The assembly may include a lanyard connected to the padlock cover whereby the cover may hang from the lanyard when the lanyard is connected to a support structure. The assembly may also include a connecting member connected to the cover and configured to connect to a lock shank of the padlock.

### BACKGROUND OF THE INVENTION

1. Technical Field

The present invention relates generally to protective covers for padlocks. More particularly, the present invention relates to a padlock cover which may be secured to a supporting structure such as a wall, doorframe, door or fence.

2. Background Information

The use of padlocks, especially outdoors, often leads to the inability to use the lock either permanently or for some duration because of, for instance, dirt or grit entering the lock or keyhole, or ice which also makes it difficult to unlock the padlock, or rain or other conditions which may lead to rust of various padlock components. A variety of protective covers for padlocks have been invented over the years, including rigid covers as well as flexible covers made of leather, textile materials, rubber or the like. Some of these padlock covers are in a form of a box having a rigid base and rigid lid hingedly connected to one another so that the padlock may be positioned within the closed box to provide a barrier to weather and other outdoor elements. However, these types of structures are relatively expensive and bulky, thus taking up a relatively substantial amount of space compared to other types of covers which may fit around the padlock more snugly. A variety of the flexible covers have pockets or compartments into which the padlock may be inserted and from which it may be removed. However, when the padlock is removed from these types of covers and a gate or door to which the padlock was used to secure is opened, these types of covers are separated from the lock and are free floating components which are not anchored to anything. Thus, such covers may be easily misplaced, lost or even stolen. The present invention addresses this and other problems in the art.

### BRIEF SUMMARY OF THE INVENTION

The present invention generally provides a padlock protector or cover assembly which includes a padlock cover and may include a lanyard from which the cover may hang or a connecting member for connecting the cover to a lock shank of the padlock.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a front elevational view of a first embodiment of the padlock cover assembly of the present invention showing the padlock in a secured and locked position with the body of the padlock within the cover in a closed position. The lanyard extends laterally between the cover and the supporting structure.

FIG. 2 is similar to FIG. 1 and shows the padlock in an unsecured and unlocked position hanging from the hasp and the cover in an open position with the body of the padlock removed from the padlock compartment.

FIG. 3 is similar to FIG. 2 and shows the padlock cover hanging downwardly from the generally vertical lanyard.

FIG. 4 is a front elevational view of a second embodiment of the padlock cover assembly having the same padlock cover as the first embodiment with a lanyard having a different securing mechanism secured to the supporting structure in the form of a fence. FIG. 4 also shows the body of the lock within the padlock compartment and the lock shank secured through links of a chain or terminal loops of a cable.

FIG. 5 is similar to FIG. 4 and shows the padlock cover hanging downwardly from the lanyard and the unlocked padlock separated from the cover.

FIG. 6 is a front elevational view similar to FIG. 1 showing a third embodiment of the padlock cover assembly in the closed position with the entire padlock disposed within the padlock compartment.

FIG. 7 is similar to FIG. 6 and shows the padlock in the unlocked position removed from the padlock compartment and separated from the cover, which hangs from the lanyard.

FIG. 8 is a front elevational view similar to FIG. 1 of a fourth embodiment of the padlock cover assembly with the padlock hanging from a hasp and the body of the padlock within the padlock compartment of the cover, the lanyard extending laterally to the supporting structure and the closed loop or ring connecting member extending from the cover to the lock shank.

FIG. 9 is similar to FIG. 8 and shows the padlock in an unlocked and unsecured position with the cover moved to the side so that the body of the padlock is removed from the padlock compartment and the closed loop connecting member extending from the cover to the lock shank.

FIG. 10 is similar to FIG. 9 and shows the cover hanging downwardly from the lanyard and the padlock hanging downwardly from the connecting member.

FIG. 11 is a front elevational view of a fifth embodiment of the padlock cover assembly with the padlock locked to a hasp, the body of the padlock within the padlock compartment and the connecting member extending from the cover to the lock shank.

FIG. 12 is similar to FIG. 11 and shows the unlocked padlock hanging from the hasp with the body of the padlock removed from the cover, and the connecting member extending from the cover to the lock shank.

Similar numbers refer to similar parts throughout the drawings.

### DETAILED DESCRIPTION OF THE INVENTION

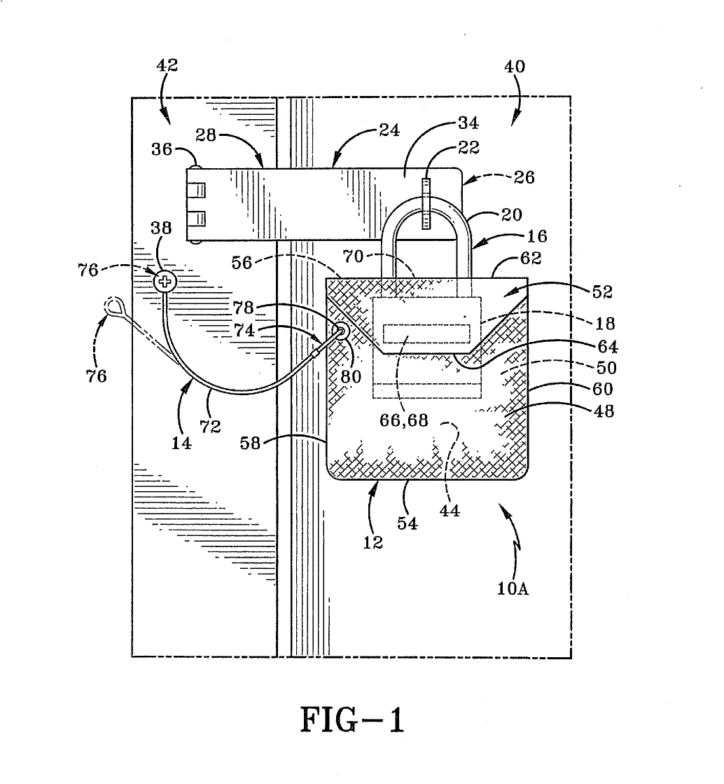

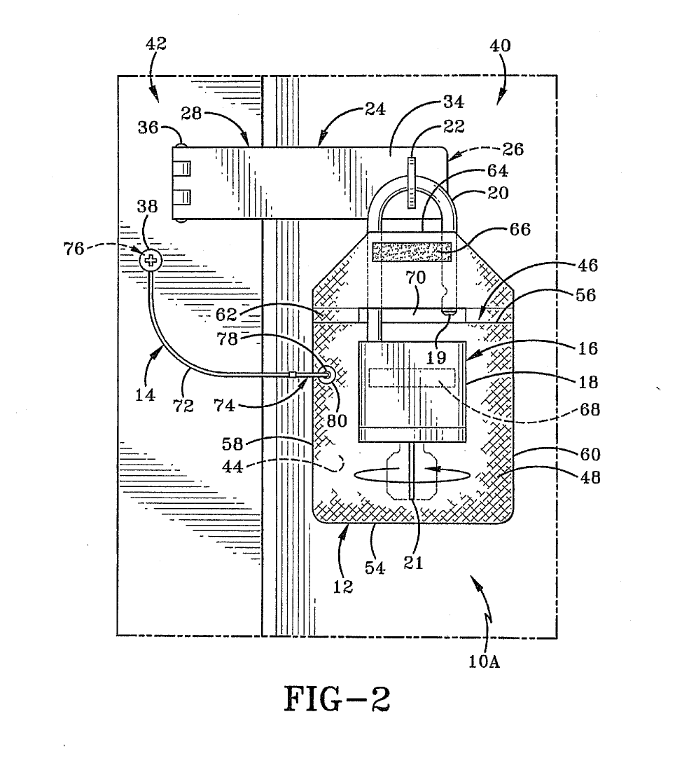

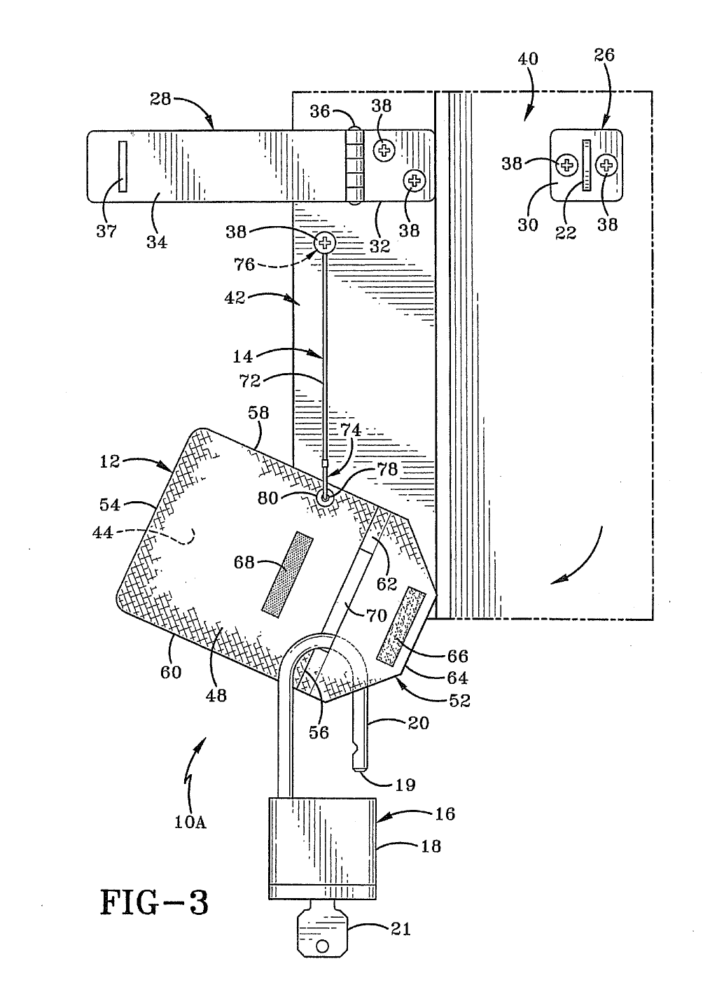

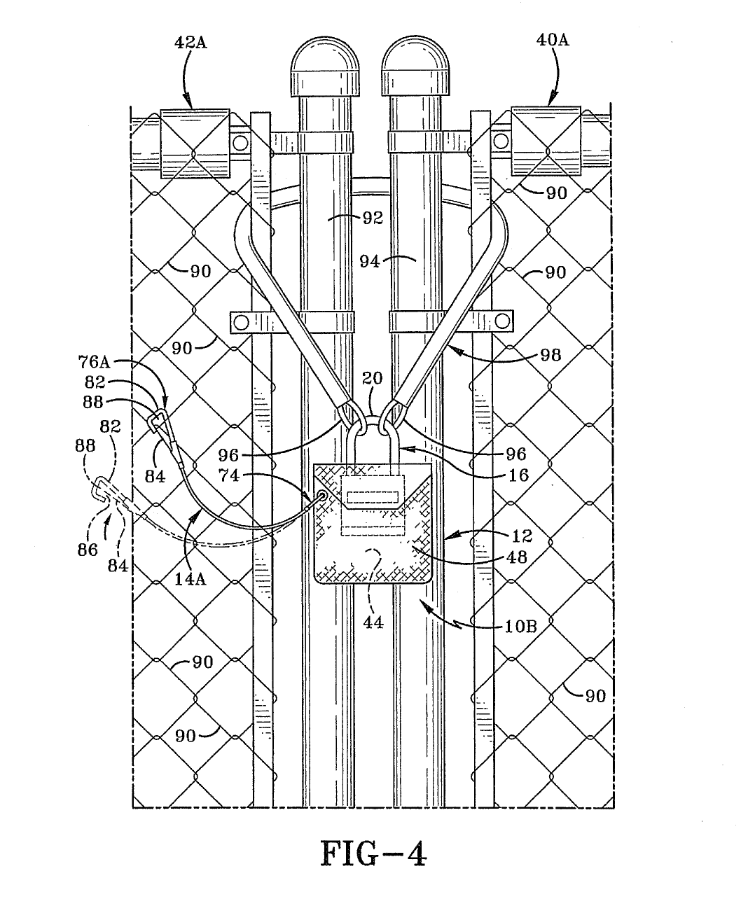

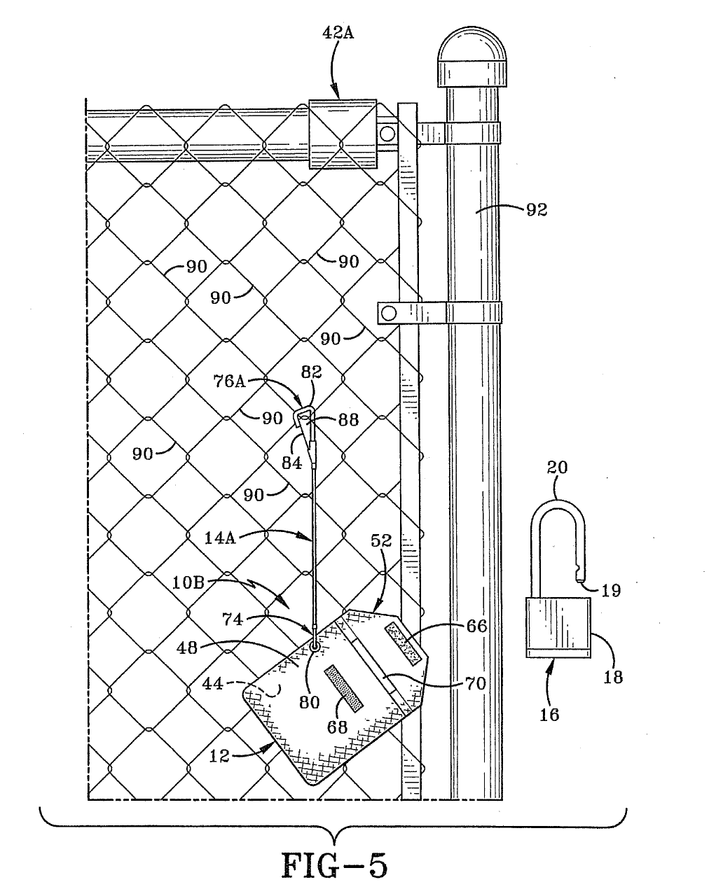

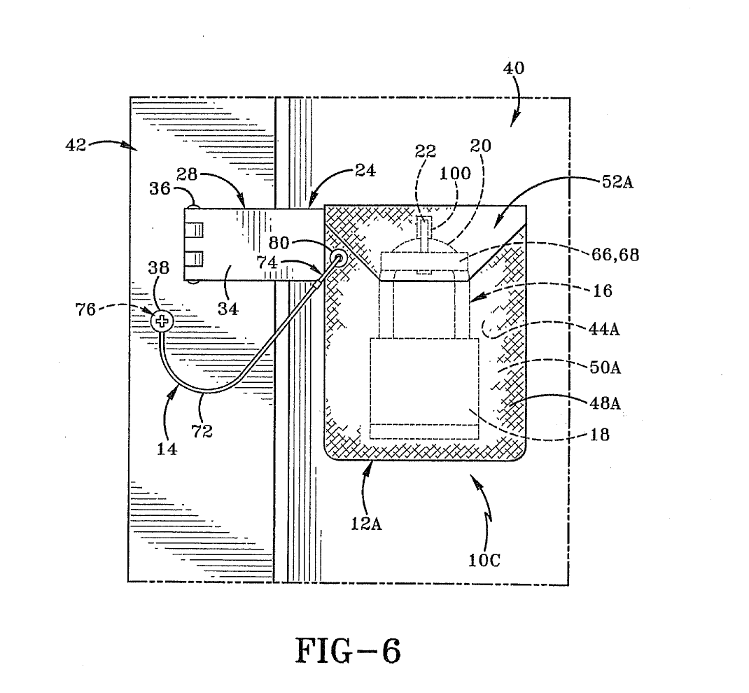

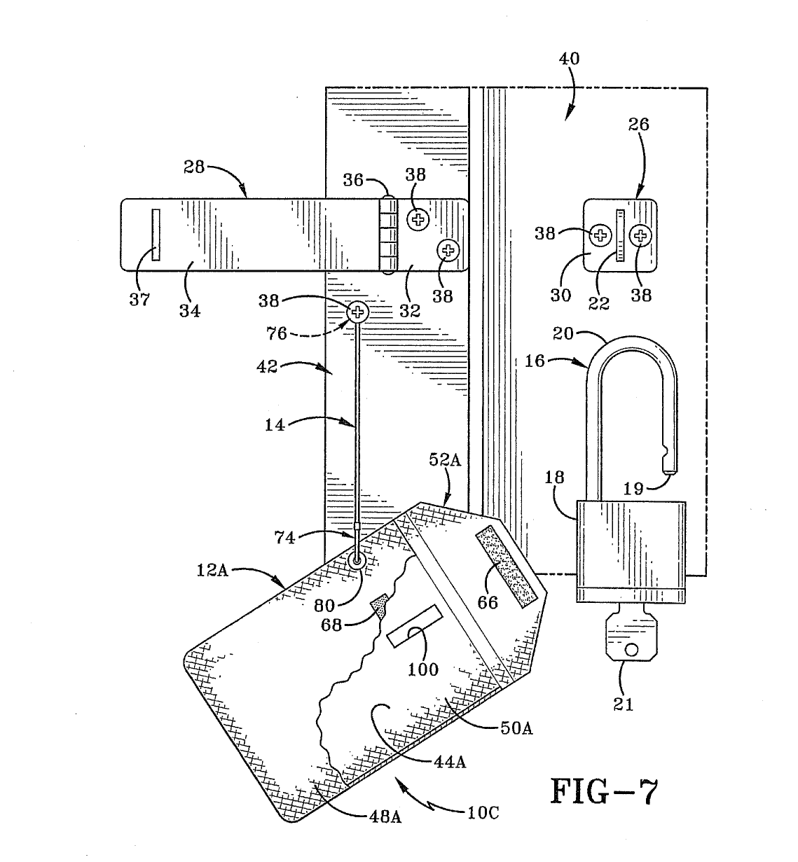

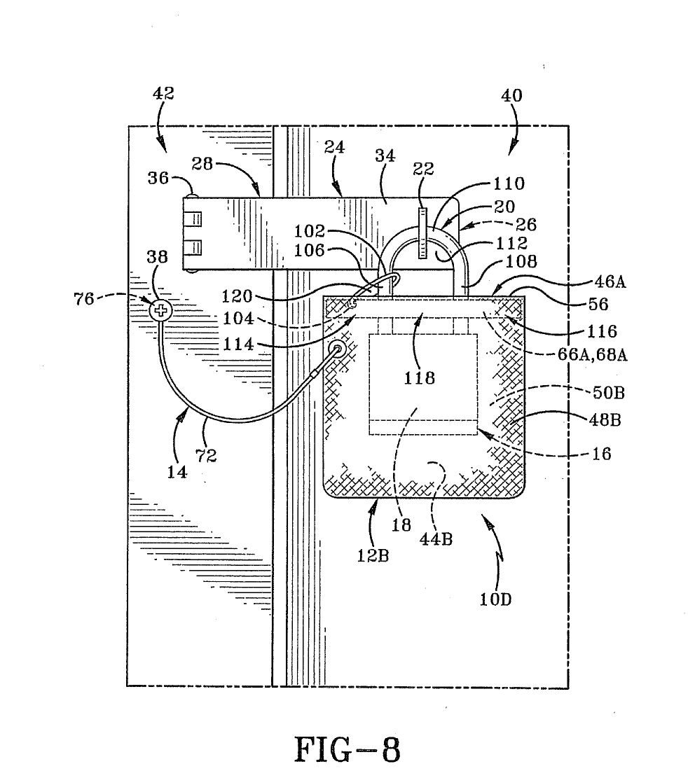

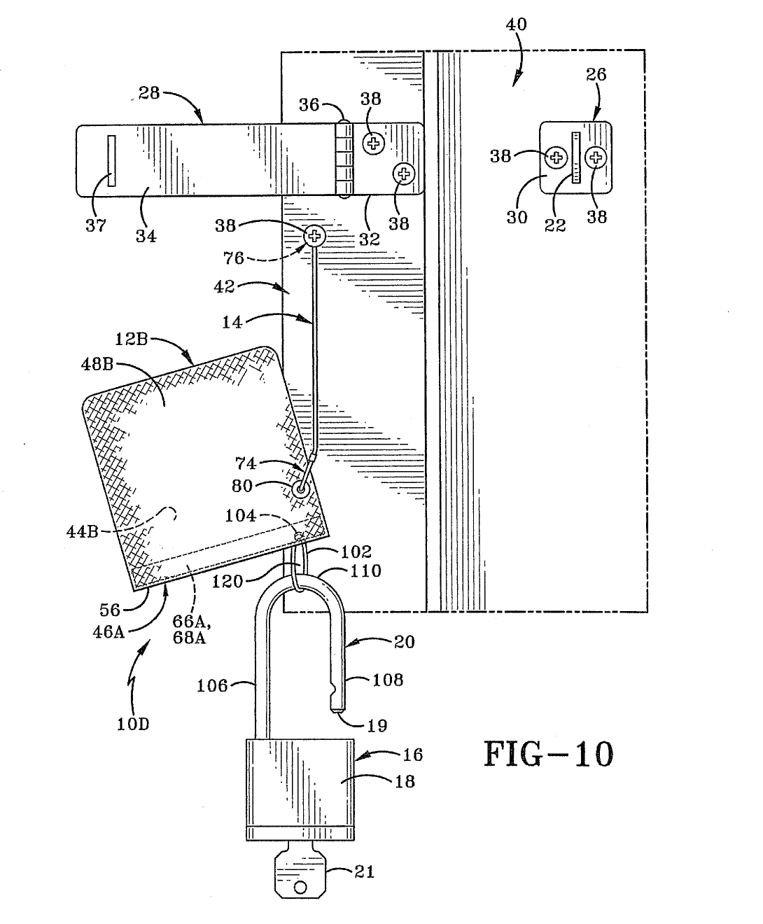

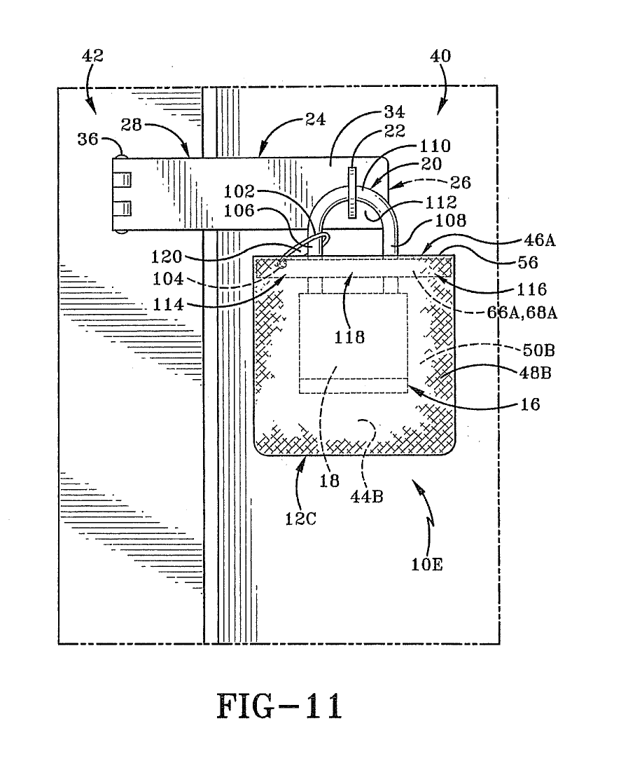

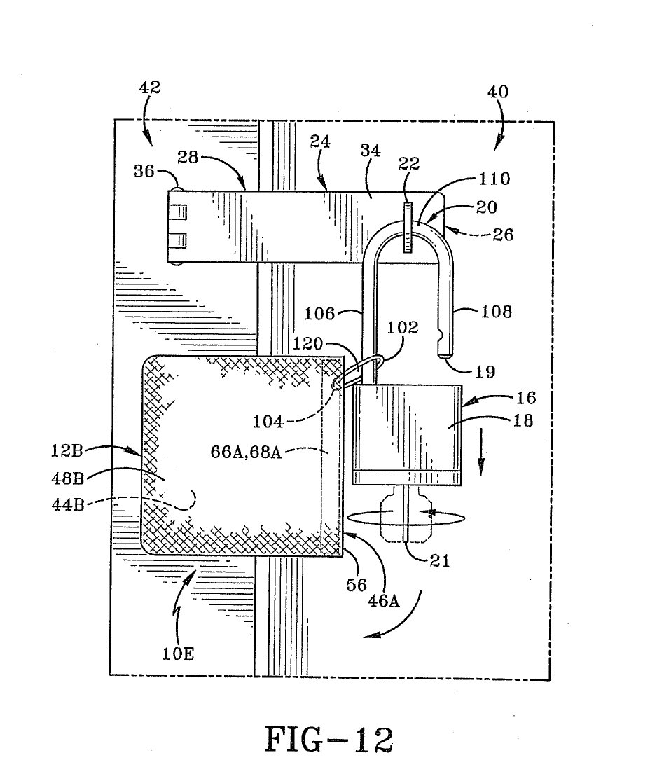

A first embodiment of the padlock cover assembly of the present invention is shown generally at 10A in FIGS. 1-3; the second embodiment is shown generally at 10B in FIGS. 4 and 5; the third embodiment is shown generally at 10C in FIGS. 6 and 7; the fourth embodiment is shown generally at 10D in FIGS. 8-10; and a fifth embodiment is shown generally at 10E in FIGS. 11 and 12. Referring to FIGS. 1-3, assembly 10A is now described. Padlock cover assembly 10A includes a generally flexible padlock cover 12, and a lanyard 14 which is secured to and extends outwardly from cover 12. Cover 12 is configured to removably receive therein all or part of a padlock 16 which includes a rigid body 18 and a U-shaped rigid lock shank 20 which has a free end 19 and which is movable relative to body 18 between a securing position shown in FIG. 1 with free end 19 within body 18 and a non-securing position shown in FIGS. 2 and 3 with free end 19 outside body 18 when padlock 16 is in an unlocked condition. When padlock 16 is in the securing position and locked, lock shank 20 cannot move from the securing position to the unsecuring position. Padlock 16 in the exemplary embodiment is configured to be unlocked by a key 21 although the padlock may be a combination lock which is opened by use of a combination instead of a key which is distinct from the padlock and is removable and separable therefrom. FIG. 1 illustrates that lock shank 20 may extend through a hole formed in a hasp 22 of a securing mechanism 24 so that when padlock 16 is in its securing and locked positions, it locks securing mechanism 24 to, for instance, prevent the opening of a door or gate etc.

With reference to FIG. 3, securing mechanism 24 includes a hasp assembly 26 and a lock arm assembly 28. Hasp assembly 26 includes a rigid mounting plate 30 and hasp 22, which is rigidly secured to and extends outwardly forward from mounting plate 30. Lock arm assembly 28 also includes a rigid mounting plate 32 and a flat rectangular rigid lock arm 34 which is pivotally or hingedly connected to mounting plate 30 by a pivot or hinge 36 whereby lock arm 34 is pivotable between a secured position shown in FIGS. 1 and 2 and an unsecured position shown in FIG. 3. Lock arm 34 defines a slot 37 therethrough so that hasp 22 is disposed in and extends through slot 37 in the secured position of securing mechanism 24. Thus, lock arm 34 adjacent slot 37 engages mounting plate 30 and/or hasp 22 in the secured position and is disengaged therefrom in the unsecured position. Each of mounting plates 30 and 32 define holes therethrough which receive therein suitable fasteners such as threaded fasteners typically in the form of screws 38 in order to respectively secure plate 30 to a first supporting structure 40 and plate 32 to a second supporting structure 42. First supporting structure 40 is typically in the form of a door or gate which is movable relative to the second supporting structure 42, which is typically in the form of a wall, doorframe or the like, or may, for example, be another door or gate. Thus, the first structure 40, such as a door or gate, is secured and locked in a closed position such as in FIG. 1, and may be moved relative to second structure 42 to an open position when the padlock 16 has been removed from hasp 22 to allow lock arm 34 to pivot to its unsecured position. Where second structure 42 is a door or gate, it may likewise be moved relative to first structure 40.

With continued reference to FIGS. 1-3, cover assembly 10A is described in greater detail. Cover 12 is formed primarily of flexible materials typically including one or more layers of flexible material which are configured to define a padlock compartment 44 having an entrance opening 46 into which the body 18 and/or lock shank 20 of the padlock may be inserted into compartment 44 and removed therefrom when cover 12 is in its open position shown in FIG. 2. More particularly, cover 12 includes a front flexible layer or panel 48, a back flexible layer or panel 50 which are secured to one another to define therebetween the interior chamber or compartment 44, and a closure flap 52 which is secured to the top of back panel 50 and is movable between a closed position shown in FIG. 1 and an open position shown in FIGS. 2 and 3. Front panel 48 has a generally horizontal bottom edge 54, a generally horizontal top edge 56, a generally vertical left edge 58 and a generally vertical right edge 60 which likewise define the respective bottom, top, left and right edges of back panel 50, which is substantially the same size as front panel 48 and is secured thereto along bottom edge 54, left edge 58 and right edge 60 while the front and back panels 48 and 50 remain unsecured or openable along top edge 56 in order to define top entrance opening 46. Thus, the top edges of the front and back panels 48 and 50 are movable in a forward or rearward direction toward and away from one another to respectively close and open entrance opening 46. When closure flap 52 is in its closed position shown in FIG. 1, it has a generally horizontal top edge 62 which is secured to the top edge 56 of back panel 50 and extends downwardly and in front of front panel 48 to a bottom terminal free edge 64.

Thus, flap 52 forms a living hinge along top edge 62 whereby flap 64 may be flipped or pivoted upwardly from the closed or covered position shown in FIG. 1 in which flap 52 covers entrance opening 46 to the open or uncovered position shown in FIG. 2 in which flap 52 does not cover and thus allows access to entrance opening 46. In the uncovered position, edge 62 serves as the bottom edge of flap 52 and edge 64 serves as the top edge of flap 52. Typically, a fastening mechanism is used to releasably secure flap 52 in the covered position of FIG. 1.

In the exemplary embodiment, a first fastener strip 66 is secured to flap 52 and a second fastener strip 68 is secured to the front of front panel 48 so that the strips 66 and 68 releasably engage one another to form a releasable connection when flap 52 is in the covered position of FIG. 1. Typically, strips 66 and 68 are part of a Velcro® or hook-and-loop fastener or the like such that one of strips 66 and 68 is the hook portion and the other of the strips is the loop portion. However, other suitable securing mechanisms may be used. A lock shank-receiving elongated slot 70 is formed through back panel 50 and/or flap 52 adjacent their inner section and is horizontally elongated from left to right for removably receiving therethrough lock shank 20.

Although cover 12 may be formed in various ways, the panels and closure flap are typically formed of flexible layers which in the exemplary embodiment are woven or textile layers of material which may or may not have waterproof lining. The front panel 48, back panel 50 and closure flap 52 may be formed from a single flexible layer of material. For instance, front panel 48 may be folded upwardly and forward relative to back panel 50 along bottom edge 54 which would thus represent a horizontal bottom fold, and be stitched vertically along left and right right side edges 58 and 60 in order to secure the front and back panels to one another and define compartment 44. In addition, flap 52 may simply be a continuation of back panel 50 extending upwardly therefrom in the open position of FIG. 2 and folded downwardly along top edge 62 in the covered position of FIG. 1. Alternately, front and back panels 48 and 50 may be separate flexible layers which are sewn together along bottom edge 54 and left and right side edges 58 and 60. Other possibilities will be evident to one skilled in the art.

Lanyard 14 includes a flexible elongated body 72 having first and second terminal ends in the form of closed loops 74 and 76. The first end or closed loop 74 is secured to cover 12 along one of its edges while the second end or closed loop 76 is configured to be secured to a supporting structure such structure 40 or 42 by a fastener such as a screw 38. In the exemplary embodiment, the threaded shaft of the screw 38 passes through the hole of the closed loop 76 and is screwed into the supporting structure to secure second end 76 thereto. A portion of lanyard 14 forming closed loop 74 passes through a hole 78 formed through cover 12 adjacent one of its edges, wherein hole 78 may be defined by a grommet 80 to provide strength to the connection to second end 74. Thus, a portion of grommet 80 and the front and back panels 48 and 50 of cover 12 along left edge 58 are disposed in the hole defined by closed loop 74. Thus, first end 74 is preferably non-removably secured to cover 12. Body 72 of lanyard 14 may be formed of any suitable flexible member which has sufficient tensile strength, and typically includes a metal cable which may be encased in a plastic coating along its length length from one end to the other.

The installation and use of cover assembly 10A is now described with reference to FIGS. 1-3. To install cover assembly 10A on the supporting structure, the fastener or screw 38 is inserted through the hole of loop 76 and screwed into a hole in supporting structure 42. Body 18 of padlock 16 is inserted through entrance opening 46 into compartment 44, and lock shank 20 is inserted through slot 70 so that free end 19 of lock shank 20 may be inserted through the hole formed in hasp 22 after lock arm 34 has been moved from the unsecured open position to the closed secured position. Body 18 and shank 20 are then moved from the unlocked and unsecured position to the secured and locked position such that padlock 16 hangs from hasp 22 to lock the door or gate represented by supporting structures 40 or 42 to the other of structures 40 and 42. Flap 52 is also moved to the closed position such that strips 66 and 68 engage one another to releasably secure flap 52 to the front of front panel 48 whereby the panels 48 and 50 and flap 52 substantially enclose body 18 with shank 20 extending outwardly through slot 70 so that shank 20 is external to compartment 44.

When the user desires to unlock padlock 16, the user pulls edge 64 of flap 52 such that strips 66 and 68 are released from one another and flap 52 moves to the open position of FIG. 2 whereby body 18 may be removed from compartment 44 via entrance opening 46 to provide access to body 18 so that key 21 may be rotated as shown at the arrow in FIG. 2 to unlock the padlock. Once the padlock is unlocked, shank 20 moves from the closed locked and secured position of FIG. 1 to to the unlocked, unsecured and open position of FIG. 2 so that shank 20 may be removed from hasp 22 (FIG. 3). The user may then either separate padlock 16 from cover 20 or leave them engaged with one another. In any case, the user will release his or her grip on cover 20 so that cover 20 swings downwardly (arrow in FIG. 3) while suspended by lanyard 14 to the hanging position shown in FIG. 3 wherein cover 12 hangs from lanyard 14 via its connection to first end 74 while the lanyard 14 assumes a substantially vertical orientation with first end 74 more or less directly below second end 76 and the corresponding fastener 38. Padlock 16 at this stage may be separated from cover 12, or for instance as shown in FIG. 3, may be positioned to hang from cover 12 with lock shank 20 extending through slot 70 with body 18 hanging downwardly therefrom. The flexible lanyard 14 thus allows the movement of first end 74 and cover 12 relative to the secured second end 76 and the corresponding supporting structures from the position shown in FIG. 1 secured on padlock 16 while padlock 16 is locked and hanging from hasp 22, through various intermediate positions such as shown in FIG. 2, to the hanging position in FIG. 3 with or without padlock 16 hanging therefrom. While hanging from lanyard 14, cover 12 and lanyard 14 are swingable about second end 76 and the associated fastener 38.

Padlock cover assembly 10B is now described with reference to FIGS. 4 and 5. Assembly 10B is similar to assembly 10A except that it includes a lanyard 14A which has a second end 76A which differs somewhat from second end 76 of lanyard 14. Unlike the closed loop 76 of lanyard 14, which is a closed loop which cannot be opened, second ends 76A has a quick release hook type configuration which may be opened and closed. The closed position is shown in solid lines in FIG. 4 and the open position is shown in dashed lines in FIG. 4. More particularly, end 76A includes a rigid generally J-shaped hook 82 and a flexible spring metal tine 84 which is movable from a closed position shown in solid lines to an open position shown in dashed lines whereby the end of tine 84 and the end of hook 82 define therebetween an entrance opening 86 to an interior space 88 within hook 82 and in the closed position the corresponding ends of tine 84 and hook 82 contact one another to form a closed loop defining interior space 88. Tine 84 is spring biased to the closed position. Thus, second end 76A is configured to easily snap onto a supporting structure 42A in the form of a chain link fence or the like.

By way of example, supporting structure 42A includes wires or narrow rods 90 of a chain link fence or another wire style fence such that one of wire or rods 90 may easily be received through entrance opening 86 into interior space 88 to secure second end 76A to the corresponding wire or rod 90. Structure 42A also includes a vertical pole 92 to which the various rods or wires 90 are secured. Likewise, structure 40A includes a vertical pole 94 and wires or rods 90 connected thereto to form a fence structure. One or both of structures 40A and 42A may be gates whereby vertical poles 92 and 94 are adjacent one another when one or both gates are closed and move away from one another when one or both are opened. FIG. 4 illustrates that shank 20 is inserted through a pair of terminal closed loops or links 96 of a cable or chain 98 which is itself looped through the openings in the fence and around vertical poles 92 and 94 when the gate or gates are closed so that padlock 16 secures the gates together via being locked to the links 96 of the cable and chain.

The operation of cover assembly 10B is similar to that of 10A except for the connection of the second end 76A to the wire or rod of a fence, as previously described. Thus, cover 12 may be moved from the position shown in FIG. 4 to the hanging position shown in FIG. 5 such that second end 74 is substantially directly below first end 76A and cover 12 hangs downwardly from second end 74 of lanyard 14A. FIG. 5 also illustrates padlock 16 being separated from cover 12, as previously discussed with respect to cover assembly 10A. Padlock 16 can obviously also hang downwardly from cover 12 in the same manner as shown and described in FIG. 3.

Padlock cover assembly 10C is now described with reference to FIGS. 6 and 7. Assembly 10C is similar to assembly 10A except that it is configured to receive therein the entire padlock 16 and thus has a structure which is slightly modified. Thus, assembly 10C includes a cover 12A which may be longer from top to bottom than is cover 12 in order to accommodate the entire padlock 16 therein. Cover 12A is a generally flexible cover formed from the same materials as discussed with respect to cover 12, and includes front and back panels 48A and 50A defining therebetween an interior chamber or padlock compartment 44A which is somewhat longer in the vertical direction than compartment 44. Cover 12A further includes a closure flap 52A which is similar to flap 52. Unlike cover 12, cover 12A does not include the horizontally elongated slot 70 (FIGS. 2, 3) for receiving therethrough lock shank 20. Instead, a vertically elongated hasp-receiving slot 100 is formed through back panel 50A in the upper portion thereof such that hasp 22 may be received through slot 100 whereby cover 20 may hang from hasp 22 when mounted thereon. Thus, cover 12A may be mounted with hasp 22 extending forward through slot 100 and lock shank 20 extending through hasp 22 while the entire padlock 16 including body 18 and lock shank 20 is fully enclosed within padlock compartment 44A between front and rear panels 48A and 50A, with flap 52A folded over and hanging downwardly in front of front panel 48A and releasably secured thereto via strips 66 and 68. As with the previous embodiments, the lanyard 14 generally extends laterally outwardly away from its connection with cover 12A when mounted on lock 22 with padlock 16 therein, and may include a portion of the body 72 which hangs downwardly from the connection with cover 12A at first end 74. As with the previous embodiments, the user may pull flap 52A forward and upwardly to release the engagement between strips 66 and 68, to allow the padlock to be removed from interior chamber 44A with shank 20 removed from hasp 22 so that cover 12A may move to the position shown in FIG. 7 in which it hangs downwardly from lanyard 14 as previously described in the earlier embodiments.

Padlock cover assembly 10D is now described with reference to FIGS. 8-10. Assembly 10D is similar to assembly 10A except that it includes a cover 12B which is somewhat different than cover 12. More particularly, cover 12B includes front and back flat flexible layers or panels 48B and 50B which are substantially the same as panels 48 and 50, but cover 12B does not include a closure flap such as flap 52. Thus, front and back panels 48B and 50B define therebetween a padlock compartment 44B which is substantially the same as compartment 44 without a flap or the like which may extend over the entrance opening 46A thereof, which is defined between the top edges 56 of front and back panels 48B and 50B. In addition, because cover 12B eliminates the use of a closure flap such as flap 52, there is no need for strips 66 and 68 positioned for releasably securing the flap to the front panel. However, strips 66A and 68A of the same sort are similarly provided to releasably secure the front and back panels 48B and 50B adjacent their top edges 56 along top entrance opening 46A. More particularly, strip 66A is stitched or otherwise secured to the inner surface of panel 48B adjacent its top edge while strip 68A is likewise secured to its inner surface of back panel 50B adjacent its upper edge 56 whereby the generally horizontal strips 66A and 68A may be moved into a releasable securing engagement when pressed together and may be released from one another by pulling the top edges of panels 48B and 50B apart from one another, which thus opens entrance opening 46A from a closed position to allow the body 18 and portions of lock shank 20 to be inserted into compartment 44B or removed therefrom.

To better explain the connection, lock shank 20 is described in greater detail. Shank 20 includes first and second substantially vertical legs 106 and 108 with a top arcuate bridge segment 110 rigidly secured to the upper ends of legs 106 and 108 and extending therebetween. Together, leg 106, leg 108, segment 110 and the top of body 18 define there within an interior space 112. Thus, when strips 66A and 68A are secured to one another, they are actually secured to one another along a top left side portion 114 of cover 12B to the left of leg 106, along a top right side portion 116 of cover 12B to the right of leg 108, and along a top middle or central portion 118 of cover 12B between legs 106 and 108 within space 112. Legs 106 and 108 each prevent strips 66A and 68A from meeting each other in the region of the respective leg when the body 18 of the padlock is within compartment 44B and legs 106 and 108 extend upwardly beyond the top edges 56 external to compartment 44B.

Cover assembly 10D further includes a connecting member 102 which is configured to connect cover 12B to lock shank 20 of padlock 16. Connecting member 102 may be a rigid or flexible annular member which may itself form a closed loop which passes through a through hole 104 formed through one or both of panels 48B and 50B typically adjacent top edges 56. Connecting member 102 may also, for instance, be a flexible strip of cloth, fabric, textile or other material and may be secured in a similar position to one or both panels 48B, 50B by stitching so that the strip extends outwardly in a looping fashion whereby the strip itself or the strip and cover together form a closed loop of the cover assembly. This annular member 102 defines an interior space or through passage 120 through which lock shank 20 is inserted so that a portion of the annular connecting member 120 passes through interior space 112 when padlock 16 is in its secured and locked position. In the exemplary embodiment, connecting member 102 is in the form of a single closed loop or link. However, connecting member 102 may, for instance, include two or more links which are innerconnected to form a short chain which is connected to both the cover 12B and which may be connected to shank 20 as well. Alternately, a short lanyard similar to but typically shorter than lanyard 14 may be used as a connecting member extending between cover 12B and shank 20.

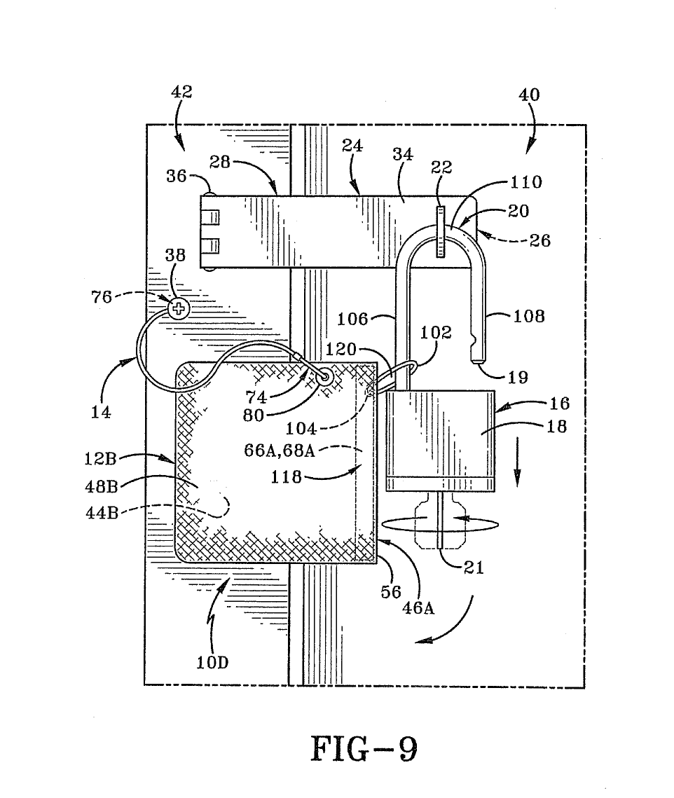

The operation of assembly 10D is similar to that of the previous embodiments in that the cover 12B may be opened to allow the user to pull body 18 and portions of lock shank 20 out of interior chamber 44B so that key 21 may be inserted into body 18 and rotated to unlock the padlock 16 as shown in FIG. 9. The body 18 may be removed from interior chamber 44B after strip 66A and 66B have been released from one another simply by pivoting the cover 12B at the loose pivotal connection provided by connecting member 102 relative to body 18, as also illustrated in FIG. 9. Once shank 20 is removed from hasp 22, cover 12B may be allowed to be moved to the hanging position where it hangs downwardly from lanyard 14 as described in the previous embodiments. In addition, shank 20 may remain looped over or hooked onto connecting member 102 such that padlock 16 hangs downwardly from cover 12B via connecting member 102. Thus, in the hanging position, cover 12B, connecting member 102 and padlock 16 may be supported solely by lanyard 14 as they hang downwardly therefrom and lanyard 14 hangs downwardly from its connection to the supporting structure to which second end 76 is secured. It is noted that lanyard 14 or 14A or other lanyards may be used with any of the preceding embodiments.

Padlock cover assembly 10E is now described with reference to FIGS. 11 and 12. Assembly 10E is similar to assembly 10D except that it does not include lanyard 14 nor the hole 86 or grommet 80 used to attach the lanyard to cover 12B of assembly 10D. Thus, assembly 10E includes a cover 12C which is the same as cover 12B with the exception of the grommet and hole noted above. Assembly 10E thus operates in the same manner as assembly 10D except that it does not ultimately hang from a lanyard. Instead, cover 12C may move from the position shown in FIG. 11 to the position shown in FIG. 12 in the manner previously described, namely by a pivotal movement relative to padlock 16 about the loose pivotal connection provided by connecting member 102 about leg 106 of shank 20 while connecting member 102 remains connected to shank 20. Although not shown, shank 20 may be easily removed from connecting member 102 when shank 20 is in the unsecured position shown in FIG. 12. Thus, connecting member 102 provides a connection between the padlock and the cover whether the padlock is received within the padlock compartment of the cover or is moved therefrom.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A padlock cover assembly comprising:
a padlock cover defining a padlock compartment adapted to receive therein and release therefrom a padlock;
a lanyard connected to and extending outwardly from the padlock cover and adapted to be connected to a support structure so that the cover may hang from the lanyard when the lanyard is connected to the support structure.

2. A padlock cover assembly comprising:
a padlock cover defining a padlock compartment for removably containing a portion of a padlock; and
a connecting member connected to and extending outwardly from the cover and adapted to connect to a lock shank of the padlock.

3. A combination comprising:
a padlock having a body and a lock shank movable relative to the body between secured and unsecured positions;
a padlock cover defining a padlock compartment for removably containing a portion of the padlock; and
a connecting member extending between and connected to the lock shank and the padlock cover.
